(19) United States
(12) Patent Application Publication
(10) Pub. No.: US 2021/0321493 A1
(43) Pub. Date: Oct. 14, 2021

(54) ELECTRIC HEATING PLATE

(71) Applicant: MIRI AMOIEV, JERUSALEM (IL)

(72) Inventor: MIRI AMOIEV, JERUSALEM (IL)

(21) Appl. No.: 17/059,232

(22) PCT Filed: May 12, 2019
(86) PCT No.: PCT/IL2019/050537

§ 371 Date: Nov. 26, 2020

(30) Foreign Application Priority Data
Jun. 4, 2018 (IL) 259814

(51) Int. Cl. H05B 3/68; F24C 15/08; F24C 15/10; F24C 15/12

(52) U.S. Cl. CPC H05B 3/68; F24C 15/12; F24C 15/10; F24C 15/08

(57) ABSTRACT

An electric heating plate (10), including: at least one horizontal extension (26A), for being extendable out of a stationary body (12) of the plate (10), thereby avoiding unintentional removal of pots (64) from the stationary body

### TECHNICAL FIELD

The invention relates to the field of heating for kitchens.

### BACKGROUND

FIG. 1 is a perspective view of a prior art electric heating plate.

The problem of the prior art electric heating plate is that a pot might fall to the side.

A stationary wall is disadvantaged in not allowing the pot to extend to the side.

There is a long felt need to provide a solution to the above-mentioned and other problems of the prior art.

### SUMMARY

An electric heating plate, including:
horizontal extensions, for being extendable out of the stationary body,
thereby avoiding unintentional removal of pots from the stationary body.

### BRIEF DESCRIPTION OF THE DRAWINGS

FIG. 1 is a perspective view of a prior art electric heating plate.

FIG. 2 is a perspective view of an electric heating plate according to one embodiment of the invention, at the non-deployed state.

FIG. 3 depicts the electric heating plate of FIG. 2 at the first step of the deployment.

FIG. 4 depicts the electric heating plate of FIG. 2 at the second step of the deployment.

FIG. 5 is a magnification of the hinge of the horizontal extension of FIG. 4.

FIG. 6 is a top exploded sectional view of the horizontal extension of FIG. 3 and of the stationary body in relation to which the horizontal extension slides.

FIG. 7 is a front exploded sectional view of the horizontal extension of FIG. 3 and of the stationary body in relation to which the horizontal extension slides.

FIG. 8 is the state of FIG. 4 according to another embodiment.

FIG. 9 is a top view of the heating plate, while pots are placed thereon.

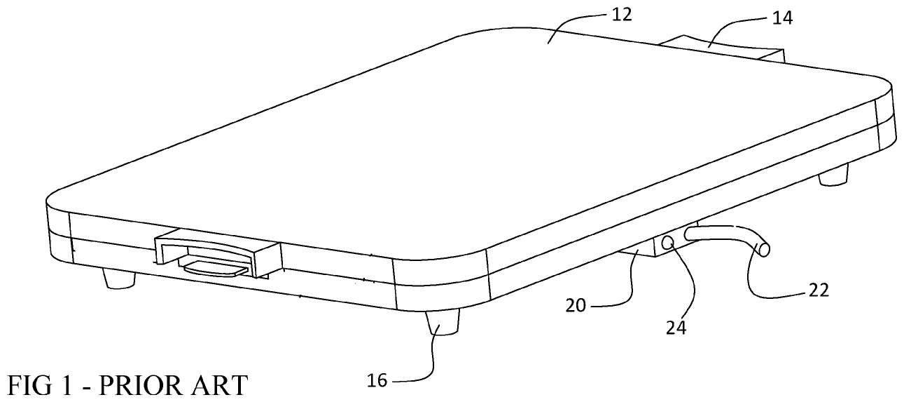

### DETAILED DESCRIPTION

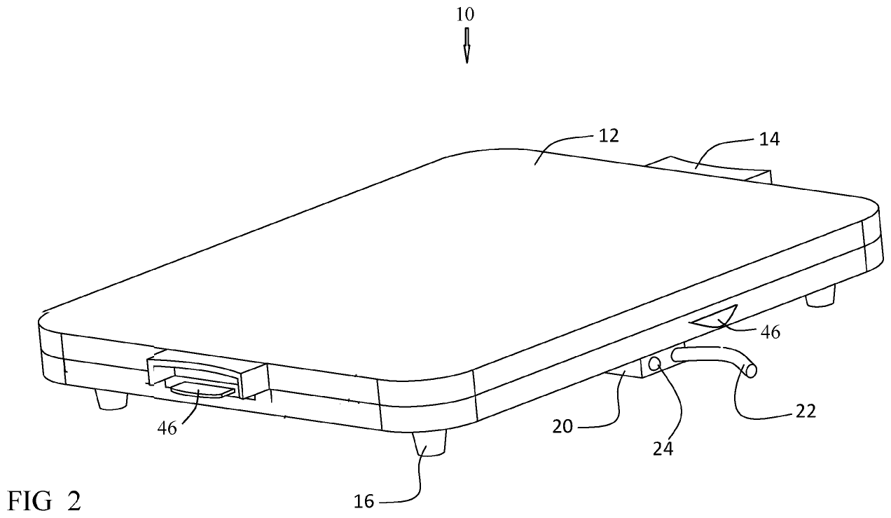

FIG. 2 is a perspective view of an electric heating plate according to one embodiment of the invention, at the non-deployed state.

An electric heating plate 10 according to one embodiment of the invention, further includes handles 46.

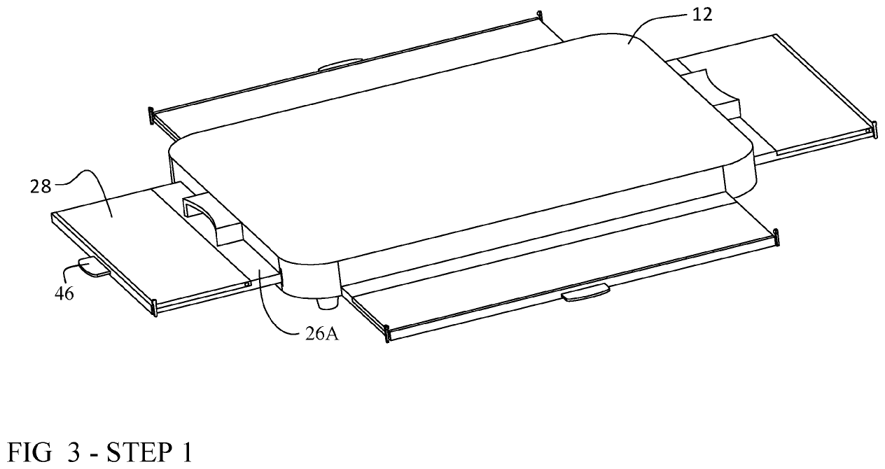

FIG. 3 depicts the electric heating plate of FIG. 2 at the first step of the deployment.

At the first step, the user pulls handles 46, thus sliding out horizontal extensions, such as 26A.

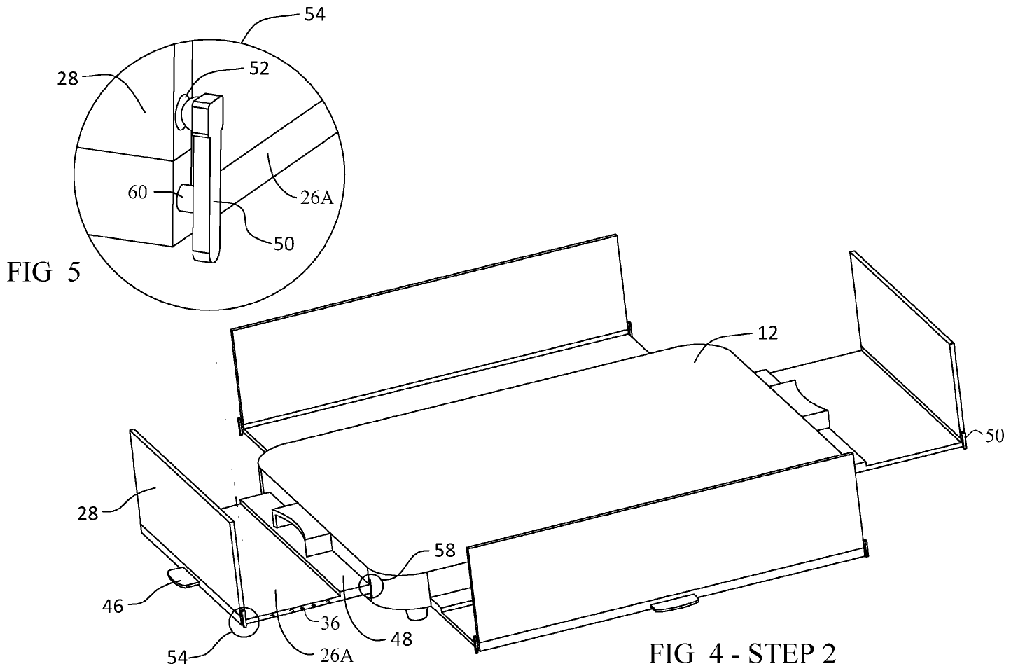

FIG. 4 depicts the electric heating plate of FIG. 2 at the second step of the deployment.

At the third step, the user unfolds rotatable walls 28 from horizontal extensions 26A and others.

FIG. 5 is a magnification of the hinge of the horizontal extension of FIG. 4.

The hinge 60 providing rotation of wall 28, preferably includes a rotational lock 50, for locking wall 28 at the unfolded state.

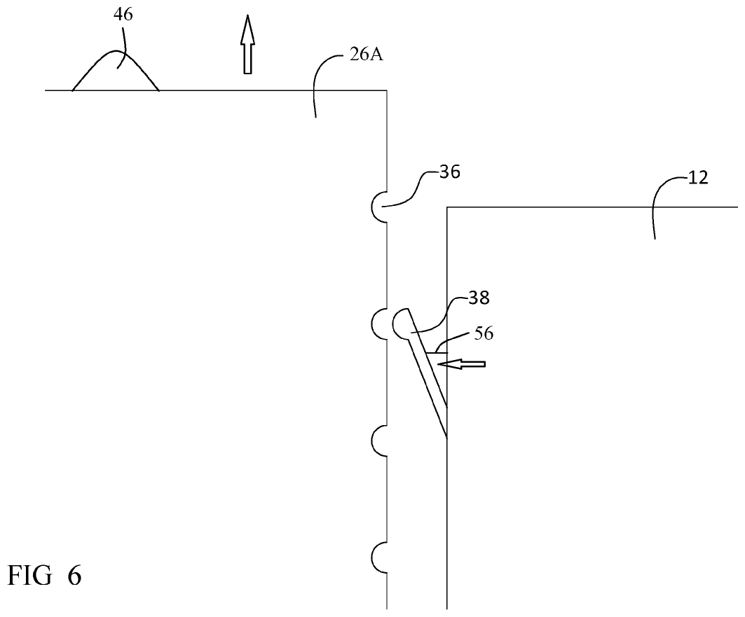

FIG. 6 is a top exploded sectional view of the horizontal extension of FIG. 3 and of the stationary body in relation to which the horizontal extension slides.

The extent of the sliding of horizontal extension 26A is adjustable by a sliding locker 38, being locked against a selected depression 36.

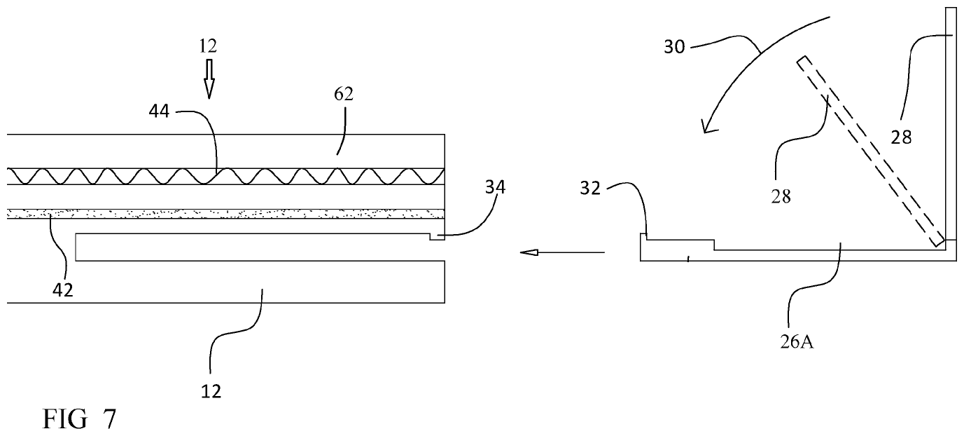

FIG. 7 is a front exploded sectional view of the horizontal extension of FIG. 3 and of the stationary body in relation to which the horizontal extension slides.

The stationary body 12 includes a top plate 62, for placing the pots thereon; and a heating element 44 below top plate 62; and an insulating plate 42, for insulating heating element 44 from horizontal extension 26A and from wall 28, being folded thereto.

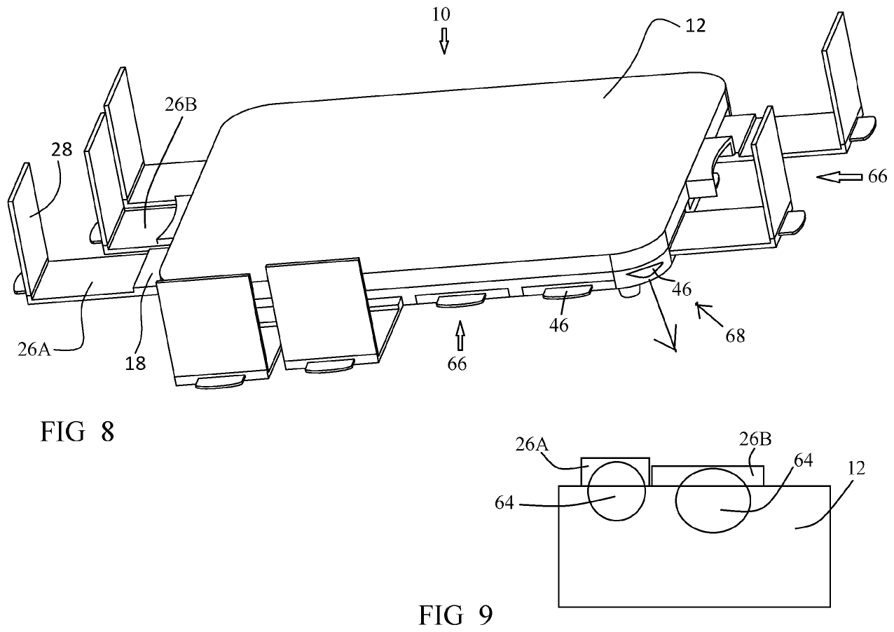

FIG. 8 is the state of FIG. 4 according to another embodiment.

A plurality of horizontal extensions 26A, 26B, etc. may extend each occupying a different portion of the perimeter of stationary body 12, and as well from the corners 68.

FIG. 9 is a top view of the heating plate, while pots are placed thereon.

Thereby, horizontal extensions 26A, 26B, etc. may be adjusted to guard the current pots 64 extending out of the stationary body 12, and not more.
Numeral 10 denotes the electric heating plate according to one embodiment of the invention;
numeral 12 denotes the stationary body;
numeral 16 denotes an elevating leg;
numeral 14 denotes a handle;
numeral 20 denotes the electric box;
numeral 22 denotes the electric cable;
numeral 24 denotes the indicating bulb;
numerals 26A and 26B denote horizontal extensions;
numeral 28 denotes the rotatable wall;
numeral 30 denotes rotation of the rotatable wall;
numerals 32 and 34 denotes protrusions, for avoiding removal of horizontal extension 26A from stationary body 12;
numeral 36 denotes a depression;
numeral 38 denotes a sliding locker;
numeral 42 denotes the insulating plate;
numeral 44 denotes the heating element;
numeral 46 denotes a handle;
numeral 50 denotes the rotational lock, for locking wall 28 vertically;
numeral 52 denotes a depression of rotational lock 50;
numeral 54 is a magnified zone;
numeral 56 denotes a spring;
numeral 60 denotes a hinge;
numeral 62 denotes the top plate;
numeral 66 denotes the side of the stationary body; and
numeral 68 denotes the corner of the stationary body.

The reference numbers in the claims should not be interpreted as limiting the claims in any form.

What is claimed is:

1. An electric heating plate (10), comprising:
at least one horizontal extension (26A), for being extendable out of a stationary body (12) of said plate (10),
thereby avoiding unintentional removal of pots (64) from said stationary body (12).

2. An electric heating plate (10) according to claim 1, further comprising:
a wall (28), for extending from said at least one horizontal extension (26A), said wall (28) for being disposed upright,
thereby said wall (28) avoids unintentional removal of the pots (64) from said at least one horizontal extension (26A).

3. An electric heating plate (10) according to claim 3, wherein said extending of said wall (28) from said at least one horizontal extension (26A) comprises at least one hinge (60), for allowing rotation (30) therebetween.

4. An electric heating plate (10) according to claim 1, wherein said extendibility of said at least one horizontal extension (26A) from said stationary body (12) comprises horizontal slideability,
thereby allowing adjusting an extent of said extendibility.

5. An electric heating plate (10) according to claim 1, wherein said at least one horizontal extension (26A) comprises a plurality of horizontal extensions (26A, 26B), each occupying a different portion of a perimeter of said stationary body (12),
thereby each of said horizontal extensions (26A, 26B) is independently adjustable, thereby allowing fitting thereof to current disposition of the pots (64).

6. An electric heating plate (10) according to claim 1, further comprising:
an insulating plate (42), for insulating said at least one horizontal extension (26A) from a heating element (44) of said electric heating plate (10).
